(19) United States
(12) Patent Application Publication
(10) Pub. No.: US 2024/0092003 A1
(43) Pub. Date: Mar. 21, 2024

(54) INJECTION MOLDING MACHINE

(71) Applicant: SUMITOMO HEAVY INDUSTRIES, LTD., Tokyo (JP)

(72) Inventors: Daigo HOTTA, Chiba-shi (JP); Takasue YAMAGUCHI, Chiba-shi (JP); Takuya MIZUNASHI, Chiba-shi (JP)

(21) Appl. No.: 18/365,895

(22) Filed: Aug. 4, 2023

(30) Foreign Application Priority Data
Sep. 16, 2022 (JP) 2022-148558

(51) Int. Cl. B29C 45/76

(52) U.S. Cl. CPC B29C 45/76; B29C 2945/76939

(57) ABSTRACT

An injection molding machine includes: a controller; components that are attachable to and detachable from the injection molding machine; and a storage medium that stores history information for each of the components, in which, in a case where the controller detects a change in attachment/detachment of a first component, the controller adds information indicating that the first component has been replaced to the history information, outputs an indication of initialization of the history information of the first component, or initializes the history information of the first component.

### CROSS-REFERENCE TO RELATED APPLICATIONS

This application claims priority to Japanese Patent Application No. 2022-148558, filed on Sep. 16, 2022, which is incorporated by reference herein in its entirety.

### BACKGROUND

### Technical Field

A certain embodiment of the present invention relates to an injection molding machine.

### Description of Related Art

In the related art, a technique has been proposed for an injection molding machine to manage histories of components provided in the injection molding machine. For example, the related art discloses a technique for estimating a degree of deterioration of a component based on a load generated in one shot and on the number of shots, and managing the degree of deterioration.

### SUMMARY

According to an embodiment of the present invention, there is provided an injection molding machine including: a controller; components that are attachable to and detachable from the injection molding machine; and a storage medium that stores history information for each of the components, in which, in a case where the controller detects a change in attachment/detachment of a first component, the controller adds information indicating that the first component has been replaced to the history information, outputs an indication of initialization of the history information of the first component, or initializes the history information of the first component.

### BRIEF DESCRIPTION OF THE DRAWINGS

FIG. 1 is a view showing a state when mold opening is completed in an injection molding machine according to an embodiment.

FIG. 2 is a view showing a state when mold clamping is performed in the injection molding machine according to the embodiment.

FIG. 3 is a functional block diagram showing components of a control device of the injection molding machine according to the embodiment and storage media of components mounted on the injection molding machine.

FIG. 4 is a view illustrating a table structure of a replacement history storage unit according to the embodiment.

FIG. 5 shows a screen example of a display of a list of loads of components displayed by a display control unit according to the embodiment.

FIG. 6 is a flowchart showing first control related to a replacement of a component in the control device according to the embodiment.

FIG. 7 is a view illustrating a notification screen of the replaced component displayed by the display control unit according to the embodiment.

FIG. 8 shows a screen example of a display of a list of loads of components after the replacement of the component, which is displayed by the display control unit according to the embodiment.

FIG. 9 is a flowchart showing second control related to the replacement of the component in the control device according to the embodiment.

FIG. 10 is a view illustrating a confirmation screen as to whether or not a component has been replaced, which is displayed by the display control unit according to the embodiment.

### DETAILED DESCRIPTION

In the related art, since the degree of deterioration is estimated according to the number of shots, it is necessary to initialize the degree of deterioration at the time when the component is replaced. The initialization of the degree of deterioration is often performed at a customer's site. Therefore, there may be cases where the initialization of the degree of deterioration is not performed due to a worker forgetting to perform the initialization operation. In this case, a situation arises in which the degree of deterioration of the component is not properly managed.

It is desirable to provide a technique for properly managing a history of a component by processing information regarding the history of the component stored in an injection molding machine in a case where a change in attachment/detachment of the component is detected.

Hereinafter, embodiments of the present invention will be described with reference to the drawings. In addition, the embodiments described below are merely examples that do not limit the invention, and all the features and combinations thereof described in the embodiments are not necessarily essential to the invention. In each drawing, the same or corresponding reference numerals will be assigned to the same or corresponding configurations, and description thereof will be omitted.

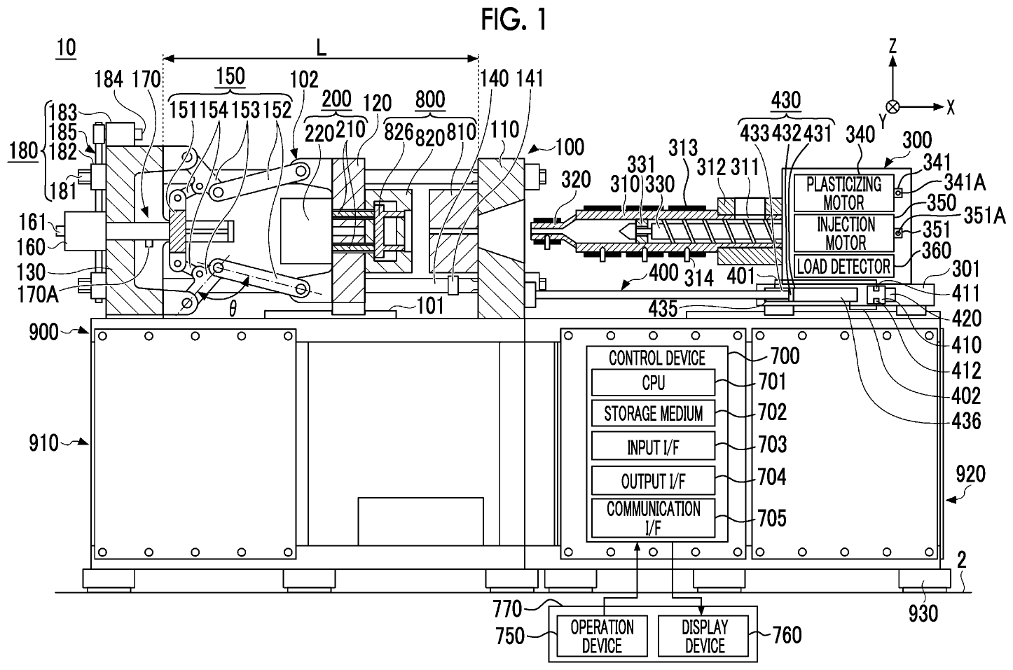

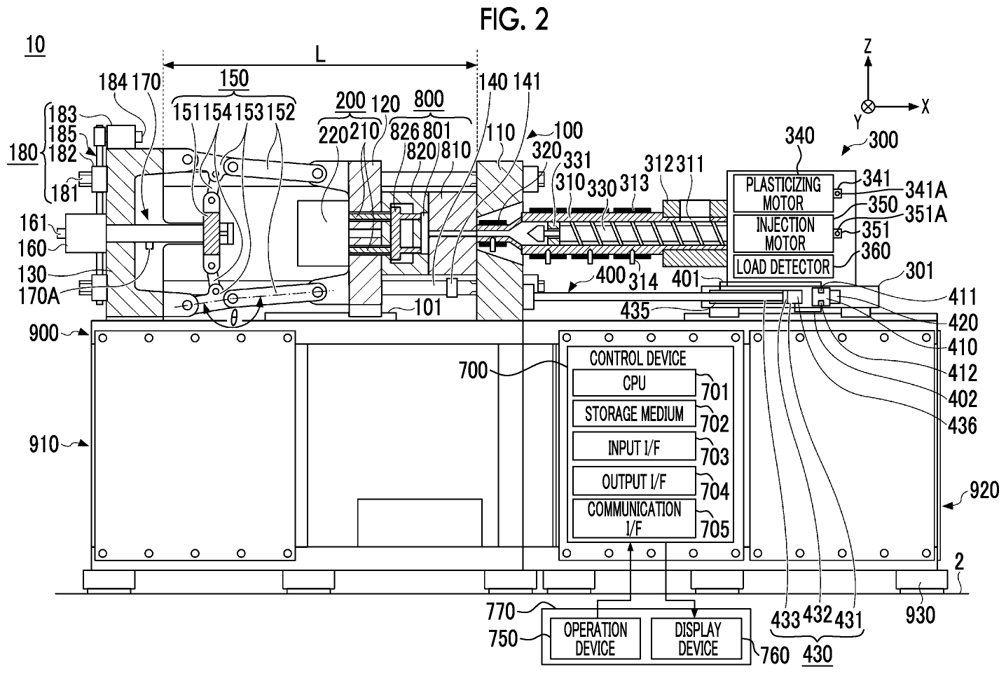

FIG. 1 is a view showing a state when mold opening is completed in an injection molding machine according to one embodiment. FIG. 2 is a view showing a state when mold clamping is performed in the injection molding machine according to one embodiment. In the present specification, an X-axis direction, a Y-axis direction, and a Z-axis direction are perpendicular to each other. The X-axis direction and the Y-axis direction represent a horizontal direction, and the Z-axis direction represents a vertical direction. In a case where a mold clamping unit 100 is of a horizontal type, the X-axis direction represents a mold opening and closing direction, and the Y-axis direction represents a width direction of an injection molding machine 10. A negative side in the Y-axis direction will be referred to as an operation side, and a positive side in the Y-axis direction will be referred to as a counter operation side.

As shown in FIGS. 1 and 2, the injection molding machine 10 includes the mold clamping unit 100 that opens and closes a mold unit 800, an ejector unit 200 that ejects a molding product molded by the mold unit 800, an injection unit 300 that injects a molding material into the mold unit 800, a moving unit 400 that causes the injection unit 300 to advance and retreat with respect to the mold unit 800, a control device 700 that controls each component of the injection molding machine 10, and a frame 900 that supports each component of the injection molding machine 10. The frame 900 includes a mold clamping unit frame 910 that supports the mold clamping unit 100, and an injection unit frame 920 that supports the injection unit 300. The mold clamping unit frame 910 and the injection unit frame 920 are respectively installed on a floor 2 via a leveling adjuster 930. The control device 700 is disposed in an internal space of the injection unit frame 920. Hereinafter, each component of the injection molding machine 10 will be described.

### Mold Clamping Unit

In describing the mold clamping unit 100, a moving direction of a movable platen 120 during mold closing (for example, a positive direction of an X-axis) will be defined as forward, and a moving direction of the movable platen 120 during mold opening (for example, a negative direction of the X-axis) will be defined as rearward.

The mold clamping unit 100 performs mold closing, pressurizing, mold clamping, depressurizing, and mold opening of the mold unit 800. The mold unit 800 includes a stationary mold 810 and a movable mold 820. For example, the mold clamping unit 100 is of a horizontal type, and the mold opening and closing direction is a horizontal direction. The mold clamping unit 100 includes a stationary platen 110 to which the stationary mold 810 is attached, the movable platen 120 to which the movable mold 820 is attached, and a moving mechanism 102 that moves the movable platen 120 in the mold opening and closing direction with respect to the stationary platen 110.

The stationary platen 110 is fixed to the mold clamping unit frame 910. The stationary mold 810 is attached to a surface of the stationary platen 110 facing the movable platen 120.

The movable platen 120 is disposed to be movable in the mold opening and closing direction with respect to the mold clamping unit frame 910. A guide 101 that guides the movable platen 120 is laid on the mold clamping unit frame 910. The movable mold 820 is attached to a surface of the movable platen 120 facing the stationary platen 110.

The moving mechanism 102 causes the movable platen 120 to advance and retreat with respect to the stationary platen 110 such that mold closing, pressurizing, mold clamping, depressurizing, and mold opening of the mold unit 800 are performed. The moving mechanism 102 includes a toggle support 130 disposed at an interval from the stationary platen 110, a tie bar 140 that connects the stationary platen 110 and the toggle support 130 to each other, a toggle mechanism 150 that moves the movable platen 120 in the mold opening and closing direction with respect to the toggle support 130, a mold clamping motor 160 that operates the toggle mechanism 150, a motion conversion mechanism 170 that converts a rotary motion into a linear motion of the mold clamping motor 160, and a mold space adjustment mechanism 180 that adjusts an interval between the stationary platen 110 and the toggle support 130.

The toggle support 130 is disposed at an interval from the stationary platen 110, and is placed on the mold clamping unit frame 910 to be movable in the mold opening and closing direction. The toggle support 130 may be disposed to be movable along a guide laid on the mold clamping unit frame 910. The guide of the toggle support 130 may be common to the guide 101 of the movable platen 120.

In the present embodiment, the stationary platen 110 is fixed to the mold clamping unit frame 910, and the toggle support 130 is disposed to be movable in the mold opening and closing direction with respect to the mold clamping unit frame 910. However, the toggle support 130 may be fixed to the mold clamping unit frame 910, and the stationary platen 110 may be disposed to be movable in the mold opening and closing direction with respect to the mold clamping unit frame 910.

The tie bar 140 connects the stationary platen 110 and the toggle support 130 to each other at an interval L in the mold opening and closing direction. A plurality of (for example, four) tie bars 140 may be used. The plurality of tie bars 140 are disposed parallel to each other in the mold opening and closing direction, and extend in accordance with a mold clamping force. At least one of the tie bars 140 may be provided with a tie bar strain detector 141 that measures a strain of the tie bar 140. The tie bar strain detector 141 transmits a signal indicating a measurement result thereof to the control device 700. The measurement result of the tie bar strain detector 141 is used in measuring the mold clamping force.

In the present embodiment, as a mold clamping force detector for measuring the mold clamping force, the tie bar strain detector 141 is used. However, the present invention is not limited thereto. The mold clamping force detector is not limited to a strain gauge type. The mold clamping force detector may be of a piezoelectric type, a capacitive type, a hydraulic type, an electromagnetic type, or the like, and an attachment position thereof is not limited to the tie bar 140.

The toggle mechanism 150 is disposed between the movable platen 120 and the toggle support 130, and moves the movable platen 120 in the mold opening and closing direction with respect to the toggle support 130. The toggle mechanism 150 has a crosshead 151 that moves in the mold opening and closing direction, and a pair of link groups bent and stretched by a movement of the crosshead 151. Each of the pair of link groups has a first link 152 and a second link 153 which are connected to be freely bent and stretched by a pin or the like. The first link 152 is oscillatingly attached to the movable platen 120 by a pin or the like. The second link 153 is oscillatingly attached to the toggle support 130 by a pin or the like. The second link 153 is attached to the crosshead 151 via a third link 154. When the crosshead 151 is caused to advance and retreat with respect to the toggle support 130, the first link 152 and the second link 153 are bent and stretched, and the movable platen 120 advances and retreats with respect to the toggle support 130.

A configuration of the toggle mechanism 150 is not limited to configurations shown in FIGS. 1 and 2. For example, in FIGS. 1 and 2, the number of nodes in each link group is five, but may be four. One end portion of the third link 154 may be connected to the node between the first link 152 and the second link 153.

The mold clamping motor 160 is attached to the toggle support 130, and operates the toggle mechanism 150. The mold clamping motor 160 causes the crosshead 151 to advance and retreat with respect to the toggle support 130 such that the first link 152 and the second link 153 are bent and stretched, and the movable platen 120 advances and retreats with respect to the toggle support 130. The mold clamping motor 160 is directly connected to the motion conversion mechanism 170, but may be connected to the motion conversion mechanism 170 via a belt, a pulley, or the like.

The motion conversion mechanism 170 converts a rotary motion of the mold clamping motor 160 into a linear motion of the crosshead 151. The motion conversion mechanism 170 includes a screw shaft and a screw nut screwed to the screw shaft. A ball or a roller may be interposed between the screw shaft and the screw nut.

The mold clamping unit 100 performs a mold closing process, a pressurizing process, a mold clamping process, a depressurizing process, a mold opening process, and the like under the control of the control device 700.

In the mold closing process, the mold clamping motor 160 is driven to cause the crosshead 151 to advance to a mold closing completion position at a set movement speed, thereby causing the movable platen 120 to advance such that the movable mold 820 touches the stationary mold 810. For example, a position or a movement speed of the crosshead 151 is measured by using a mold clamping motor encoder 161. The mold clamping motor encoder 161 measures rotation of the mold clamping motor 160, and transmits a signal indicating a measurement result thereof to the control device 700.

A crosshead position detector for measuring the position of the crosshead 151 and a crosshead movement speed detector for measuring the movement speed of the crosshead 151 are not limited to the mold clamping motor encoder 161, and a general detector can be used. In addition, a movable platen position detector for measuring a position of the movable platen 120 and a movable platen movement speed detector for measuring a movement speed of the movable platen 120 are not limited to the mold clamping motor encoder 161, and a general detector can be used.

In the pressurizing process, the mold clamping motor 160 is further driven to cause the crosshead 151 to further advance from the mold closing completion position to a mold clamping position, thereby generating a mold clamping force.

In the mold clamping process, the mold clamping motor 160 is driven to maintain the position of the crosshead 151 at the mold clamping position. In the mold clamping process, the mold clamping force generated in the pressurizing process is maintained. In the mold clamping process, a cavity space 801 (refer to FIG. 2) is formed between the movable mold 820 and the stationary mold 810, and the injection unit 300 fills the cavity space 801 with a liquid molding material. A molding product is obtained by solidifying the molding material filled therein.

The number of the cavity spaces 801 may be one or more. In the latter case, a plurality of the molding products can be obtained at the same time. An insert material may be disposed in a portion of the cavity space 801, and the other portion of the cavity space 801 may be filled with the molding material. A molding product in which the insert material and the molding material are integrated with each other can be obtained.

In the depressurizing process, the mold clamping motor 160 is driven to cause the crosshead 151 to retreat from the mold clamping position to a mold opening start position such that the movable platen 120 retreats to reduce the mold clamping force. The mold opening start position and the mold closing completion position may be the same position.

In the mold opening process, the mold clamping motor 160 is driven to cause the crosshead 151 to retreat from the mold opening start position to a mold opening completion position at a set movement speed such that the movable platen 120 retreats and the movable mold 820 is separated from the stationary mold 810. Thereafter, the ejector unit 200 ejects the molding product from the movable mold 820.

Setting conditions in the mold closing process, the pressurizing process, and the mold clamping process are collectively set as a series of setting conditions. For example, the movement speed or positions (including a mold closing start position, a movement speed switching position, the mold closing completion position, and the mold clamping position) of the crosshead 151 and the mold clamping force in the mold closing process and in the pressurizing process are collectively set as a series of setting conditions. The mold closing start position, the movement speed switching position, the mold closing completion position, and the mold clamping position are aligned in this order from a rear side toward a front side, and represent a start point and an end point of a section in which the movement speed is set. The movement speed is set for each section. The number of the movement speed switching positions may be one or more. The movement speed switching position may not be set. Only one of the mold clamping position and the mold clamping force may be set.

Setting conditions in the depressurizing process and in the mold opening process are set in the same manner. For example, the movement speed or positions (the mold opening start position, the movement speed switching position, and the mold opening completion position) of the crosshead 151 in the depressurizing process and in the mold opening process are collectively set as a series of setting conditions. The mold opening start position, the movement speed switching position, and the mold opening completion position are aligned in this order from the front side toward the rear side, and represent the start point and the end point of the section in which the movement speed is set. The movement speed is set for each section. The number of the movement speed switching positions may be one or more. The movement speed switching position may not be set. The mold opening start position and the mold closing completion position may be the same position. In addition, the mold opening completion position and the mold closing start position may be the same position.

Instead of the movement speed, positions, and the like of the crosshead 151, the movement speed, positions, and the like of the movable platen 120 may be set. In addition, instead of the position (for example, the mold clamping position) of the crosshead or the position of the movable platen, the mold clamping force may be set.

The toggle mechanism 150 amplifies a driving force of the mold clamping motor 160, and transmits the driving force to the movable platen 120. An amplification magnification is referred to as a toggle magnification. The toggle magnification is changed according to an angle θ (hereinafter, also referred to as a “link angle θ”) formed between the first link 152 and the second link 153. The link angle θ is obtained from the position of the crosshead 151. When the link angle θ is 180°, the toggle magnification is maximized.

In a case where a mold space of the mold unit 800 is changed due to replacement of the mold unit 800, a temperature change in the mold unit 800, or the like, mold space adjustment is performed so that a predetermined mold clamping force is obtained during the mold clamping. For example, in the mold space adjustment, the interval L between the stationary platen 110 and the toggle support 130 is adjusted so that the link angle θ of the toggle mechanism 150 becomes a predetermined angle at a mold touch time at which the movable mold 820 touches the stationary mold 810.

The mold clamping unit 100 has the mold space adjustment mechanism 180. The mold space adjustment mechanism 180 performs the mold space adjustment by adjusting the interval L between the stationary platen 110 and the toggle support 130. For example, a time for the mold space adjustment is determined from an end point of a molding cycle to a start point of a subsequent molding cycle. For example, the mold space adjustment mechanism 180 has a screw shaft 181 formed in a rear end portion of the tie bar 140, a screw nut 182 held by the toggle support 130 to be rotatable and not to advance and retreat, and a mold space adjustment motor 183 that rotates the screw nut 182 screwed to the screw shaft 181.

The screw shaft 181 and the screw nut 182 are provided for each of the tie bars 140. A rotational driving force of the mold space adjustment motor 183 may be transmitted to a plurality of the screw nuts 182 via a rotational driving force transmitting unit 185. The plurality of screw nuts 182 can be rotated in synchronization with each other. The plurality of screw nuts 182 can be individually rotated by changing a transmission channel of the rotational driving force transmitting unit 185.

For example, the rotational driving force transmitting unit 185 is configured to include a gear. In this case, a driven gear is formed on an outer periphery of each screw nut 182, a driving gear is attached to an output shaft of the mold space adjustment motor 183, and a plurality of intermediate gears meshing with the driven gear and the driving gear are held to be rotatable in a central portion of the toggle support 130. The rotational driving force transmitting unit 185 may be configured to include a belt, a pulley, or the like instead of the gear.

An operation of the mold space adjustment mechanism 180 is controlled by the control device 700. The control device 700 drives the mold space adjustment motor 183 to rotate the screw nut 182. As a result, a position of the toggle support 130 with respect to the tie bar 140 is adjusted, and the interval L between the stationary platen 110 and the toggle support 130 is adjusted. In addition, a plurality of the mold space adjustment mechanisms may be used in combination.

The interval L is measured by using a mold space adjustment motor encoder 184. The mold space adjustment motor encoder 184 measures a rotation amount or a rotation direction of the mold space adjustment motor 183, and transmits a signal indicating a measurement result thereof to the control device 700. The measurement result of the mold space adjustment motor encoder 184 is used in monitoring or controlling the position or the interval L of the toggle support 130. A toggle support position detector for measuring the position of the toggle support 130 and an interval detector for measuring the interval L are not limited to the mold space adjustment motor encoder 184, and a general detector can be used.

The mold clamping unit 100 may include a mold temperature controller that adjusts a temperature of the mold unit 800. The mold unit 800 internally has a flow path of a temperature control medium. The mold temperature controller adjusts the temperature of the mold unit 800 by adjusting a temperature of the temperature control medium supplied to the flow path of the mold unit 800.

The mold clamping unit 100 of the present embodiment is of the horizontal type in which the mold opening and closing direction is the horizontal direction, but may be of a vertical type in which the mold opening and closing direction is an upward-downward direction.

The mold clamping unit 100 of the present embodiment has the mold clamping motor 160 as a drive source. However, a hydraulic cylinder may be provided instead of the mold clamping motor 160. In addition, the mold clamping unit 100 may have a linear motor for mold opening and closing, and may have an electromagnet for mold clamping.

### Ejector Unit

In describing the ejector unit 200, similarly to the description of the mold clamping unit 100, a moving direction of the movable platen 120 during the mold closing (for example, the positive direction of the X-axis) will be defined as forward, and a moving direction of the movable platen 120 during the mold opening (for example, the negative direction of the X-axis) will be defined as rearward.

The ejector unit 200 is attached to the movable platen 120, and advances and retreats together with the movable platen 120. The ejector unit 200 has an ejector rod 210 that ejects a molding product from the mold unit 800, and a drive mechanism 220 that moves the ejector rod 210 in the moving direction (X-axis direction) of the movable platen 120.

The ejector rod 210 is disposed to be able to advance and retreat in a through-hole of the movable platen 120. A front end portion of the ejector rod 210 comes into contact with an ejector plate 826 of the movable mold 820. The front end portion of the ejector rod 210 may be connected to or may not be connected to the ejector plate 826.

For example, the drive mechanism 220 has an ejector motor and a motion conversion mechanism that converts a rotary motion of the ejector motor into a linear motion of the ejector rod 210. The motion conversion mechanism includes a screw shaft and a screw nut screwed to the screw shaft. A ball or a roller may be interposed between the screw shaft and the screw nut.

The ejector unit 200 performs an ejection process under the control of the control device 700. In the ejection process, the ejector rod 210 is caused to advance from a standby position to an ejection position at a set movement speed such that the ejector plate 826 advances to eject the molding product. Thereafter, the ejector motor is driven to cause the ejector rod 210 to retreat at a set movement speed such that the ejector plate 826 retreats to an original standby position.

For example, a position or a movement speed of the ejector rod 210 is measured by using an ejector motor encoder. The ejector motor encoder measures the rotation of the ejector motor, and transmits a signal indicating a measurement result thereof to the control device 700. An ejector rod position detector for measuring the position of the ejector rod 210, and an ejector rod movement speed detector for measuring the movement speed of the ejector rod 210 are not limited to the ejector motor encoder, and a general detector can be used.

### Injection Unit

In describing the injection unit 300, unlike the description of the mold clamping unit 100 or the description of the ejector unit 200, a moving direction of a screw 330 during filling (for example, the negative direction of the X-axis) will be defined as forward, and a moving direction of the screw 330 during plasticizing (for example, the positive direction of the X-axis) will be defined as rearward.

The injection unit 300 is installed on a slide base 301, and the slide base 301 is disposed to be able to advance and retreat with respect to the injection unit frame 920. The injection unit 300 is disposed to be able to advance and retreat with respect to the mold unit 800. The injection unit 300 touches the mold unit 800, and fills the cavity space 801 inside the mold unit 800 with the molding material plasticized inside a cylinder 310. For example, the injection unit 300 has the cylinder 310 that heats the molding material, a nozzle 320 provided in a front end portion of the cylinder 310, the screw 330 disposed to be able to advance and retreat and to rotate inside the cylinder 310, a plasticizing motor 340 that rotates the screw 330, an injection motor 350 that causes the screw 330 to advance and retreat, and a load detector 360 that measures a load transmitted between the injection motor 350 and the screw 330.

The cylinder 310 heats the molding material supplied into the cylinder 310 from a feed port 311. For example, the molding material includes a resin. For example, the molding material is formed in a pellet shape, and is supplied to the feed port 311 in a solid state. The feed port 311 is formed in a rear portion of the cylinder 310. A cooler 312 such as a water-cooling cylinder is provided on an outer periphery of the rear portion of the cylinder 310. In front of the cooler 312, a heating unit 313 such as a band heater and a temperature measurer 314 are provided on an outer periphery of the cylinder 310.

The nozzle 320 is provided in the front end portion of the cylinder 310, and is pressed against the mold unit 800. The heating unit 313 and the temperature measurer 314 are provided on an outer periphery of the nozzle 320. The control device 700 controls the heating unit 313 so that a measurement temperature of the nozzle 320 reaches the set temperature.

A combination of the cylinder 310 and the nozzle 320 is divided into a plurality of zones in an axial direction of the cylinder 310 (for example, the X-axis direction) in order to perform temperature control. The heating unit 313 and the temperature measurer 314 are provided in each of the plurality of zones. The control device 700 controls the heating unit 313 so that a set temperature is set in each of the plurality of zones and a measurement temperature of the temperature measurer 314 reaches the set temperature.

The screw 330 is disposed to be able to rotate and to advance and retreat inside the cylinder 310. When the screw 330 is rotated, the molding material is fed forward along a helical groove of the screw 330. The molding material is gradually melted by heat from the cylinder 310 while being fed forward. As the liquid molding material is fed forward of the screw 330 and is accumulated in a front portion of the cylinder 310, the screw 330 retreats. Thereafter, when the screw 330 is caused to advance, the liquid molding material accumulated in front of the screw 330 is injected from the nozzle 320, and fills an inside of the mold unit 800.

As a backflow prevention valve for preventing a backflow of the molding material fed rearward from the front of the screw 330 when the screw 330 is pressed forward, a backflow prevention ring 331 is attached to a front portion of the screw 330 to be able to advance and retreat.

The backflow prevention ring 331 is pressed rearward by a pressure of the molding material in front of the screw 330 when the screw 330 is caused to advance, and retreats relative to the screw 330 to a close position (refer to FIG. 2) at which a flow path of the molding material is closed. Accordingly, the molding material accumulated in front of the screw 330 is prevented from flowing rearward.

On the other hand, the backflow prevention ring 331 is pressed forward by the pressure of the molding material fed forward along the helical groove of the screw 330 when the screw 330 is rotated, and advances relative to the screw 330 to an open position (refer to FIG. 1) at which the flow path of the molding material is open. Accordingly, the molding material is fed forward of the screw 330.

The backflow prevention ring 331 may be of either a co-rotation type rotating together with the screw 330 or a non-co-rotation type that does not rotate together with the screw 330.

The injection unit 300 may have a drive source that causes the backflow prevention ring 331 to advance and retreat with respect to the screw 330 between the open position and the close position.

The plasticizing motor 340 rotates the screw 330. A drive source that rotates the screw 330 is not limited to the plasticizing motor 340, and may be a hydraulic pump, for example.

The injection motor 350 causes the screw 330 to advance and retreat. A motion conversion mechanism that converts a rotary motion of the injection motor 350 into a linear motion of the screw 330 or the like is provided between the injection motor 350 and the screw 330. For example, the motion conversion mechanism has a screw shaft and a screw nut screwed to the screw shaft. A ball or a roller may be provided between the screw shaft and the screw nut. A drive source that causes the screw 330 to advance and retreat is not limited to the injection motor 350, and may be a hydraulic cylinder, for example.

The load detector 360 measures a load transmitted between the injection motor 350 and the screw 330. The measured load is converted into a pressure by the control device 700. The load detector 360 is provided in a load transmission channel between the injection motor 350 and the screw 330, and measures the load acting on the load detector 360.

The load detector 360 transmits a signal of the measured load to the control device 700. The load measured by the load detector 360 is converted into the pressure acting between the screw 330 and the molding material, and is used in controlling or monitoring the pressure received from the molding material by the screw 330, a back pressure against the screw 330, the pressure acting on the molding material from the screw 330, or the like.

A pressure detector for measuring the pressure of the molding material is not limited to the load detector 360, and a general detector can be used. For example, a nozzle pressure sensor or a mold internal pressure sensor may be used. The nozzle pressure sensor is installed in the nozzle 320. The mold internal pressure sensor is installed inside the mold unit 800.

The injection unit 300 performs a plasticizing process, a filling process, a holding pressure process, and the like under the control of the control device 700. The filling process and the holding pressure process may be collectively referred to as an injection process.

In the plasticizing process, the plasticizing motor 340 is driven to rotate the screw 330 at a set rotational speed such that the molding material is fed forward along the helical groove of the screw 330. As a result, the molding material is gradually melted. As the liquid molding material is fed forward of the screw 330 and is accumulated in a front portion of the cylinder 310, the screw 330 retreats. For example, the rotational speed of the screw 330 is measured by using a plasticizing motor encoder 341. The plasticizing motor encoder 341 measures the rotation of the plasticizing motor 340, and transmits a signal indicating a measurement result thereof to the control device 700. A screw rotational speed detector for measuring the rotational speed of the screw 330 is not limited to the plasticizing motor encoder 341, and a general detector can be used.

In the plasticizing process, the injection motor 350 may be driven to apply a set back pressure to the screw 330 in order to limit a sudden retreat of the screw 330. The back pressure applied to the screw 330 is measured by using the load detector 360, for example. When the screw 330 retreats to a plasticizing completion position and a predetermined amount of the molding material is accumulated in front of the screw 330, the plasticizing process is completed.

The position and the rotational speed of the screw 330 in the plasticizing process are collectively set as a series of setting conditions. For example, a plasticizing start position, a rotational speed switching position, and the plasticizing completion position are set. These positions are aligned in this order from the front side toward the rear side, and represent a start point and an end point of a section in which the rotational speed is set. The rotational speed is set for each section. The number of the rotational speed switching positions may be one or more. The rotational speed switching position may not be set. In addition, the back pressure is set for each section.

In the filling process, the injection motor 350 is driven to cause the screw 330 to advance at a set movement speed, and the cavity space 801 inside the mold unit 800 is filled with the liquid molding material accumulated in front of the screw 330. The position or the movement speed of the screw 330 is measured by using an injection motor encoder 351, for example. The injection motor encoder 351 measures the rotation of the injection motor 350, and transmits a signal indicating a measurement result thereof to the control device 700. When the position of the screw 330 reaches a set position, the filling process is switched to the holding pressure process (so-called V/P switching). The position where the V/P switching is performed will be referred to as a V/P switching position. The set movement speed of the screw 330 may be changed in accordance with the position, a time, or the like of the screw 330.

The position and the movement speed of the screw 330 in the filling process are collectively set as a series of setting conditions. For example, a filling start position (also referred to as an “injection start position”), the movement speed switching position, and the V/P switching position are set. These positions are aligned in this order from the rear side toward the front side, and represent the start point and the end point of the section in which the movement speed is set. The movement speed is set for each section. The number of the movement speed switching positions may be one or more. The movement speed switching position may not be set.

An upper limit of the pressure of the screw 330 is set for each section in which the movement speed of the screw 330 is set. The pressure of the screw 330 is measured by the load detector 360. In a case where the pressure of the screw 330 is equal to or lower than a setting pressure, the screw 330 advances at a set movement speed. On the other hand, in a case where the pressure of the screw 330 exceeds the setting pressure, in order to protect the mold, the screw 330 is caused to advance at a movement speed slower than the set movement speed so that the pressure of the screw 330 is equal to or lower than the setting pressure.

After the position of the screw 330 reaches the V/P switching position in the filling process, the screw 330 may be temporarily stopped at the V/P switching position, and thereafter, the V/P switching may be performed. Immediately before the V/P switching, instead of the screw 330 being stopped, the screw 330 may be caused to advance at a low speed, or may be caused to retreat at a low speed. In addition, a screw position detector for measuring the position of the screw 330 and a screw movement speed detector for measuring the movement speed of the screw 330 are not limited to the injection motor encoder 351, and a general detector can be used.

In the holding pressure process, the injection motor 350 is driven to press the screw 330 forward. A pressure (hereinafter, also referred to as a “holding pressure”) of the molding material in a front end portion of the screw 330 is held at a set pressure, and the molding material remaining inside the cylinder 310 is pressed toward the mold unit 800. An insufficient amount of the molding material due to cooling shrinkage inside the mold unit 800 can be replenished. The holding pressure is measured by using the load detector 360, for example. A set value of the holding pressure may be changed depending on an elapsed time from the start of the holding pressure process or the like. A plurality of holding pressures and a plurality of holding times for holding the holding pressures in the holding pressure process may be respectively set, or may be collectively set as a series of setting conditions.

In the holding pressure process, the molding material in the cavity space 801 inside the mold unit 800 is gradually cooled, and when the holding pressure process is completed, an inlet of the cavity space 801 is closed by the solidified molding material. This state is referred to as gate seal, and prevents the backflow of the molding material from the cavity space 801. After the holding pressure process, a cooling process starts. In the cooling process, the molding material inside the cavity space 801 is solidified. In order to shorten a molding cycle time, the plasticizing process may be performed during the cooling process.

The injection unit 300 of the present embodiment is of an in-line screw type, but may be of a pre-plasticizing type. The pre-plasticizing type injection unit supplies the molding material melted inside a plasticizing cylinder to an injection cylinder, and the molding material is injected into the mold unit from the injection cylinder. Inside the plasticizing cylinder, the screw is disposed to be rotatable and not to advance and retreat, or the screw is disposed to be rotatable and to be able to advance and retreat. Meanwhile, a plunger is disposed to be able to advance and retreat inside the injection cylinder.

In addition, the injection unit 300 of the present embodiment is of a horizontal type in which the axial direction of the cylinder 310 is a horizontal direction, but may be of a vertical type in which the axial direction of the cylinder 310 is an upward-downward direction. The mold clamping unit combined with a vertical type injection unit 300 may be of the vertical type or the horizontal type. Similarly, the mold clamping unit combined with a horizontal type injection unit 300 may be of the horizontal type or the vertical type.

### Moving Unit

In describing the moving unit 400, similarly to the description of the injection unit 300, a moving direction of the screw 330 during the filling (for example, the negative direction of the X-axis) will be defined as forward, and a moving direction of the screw 330 during the plasticizing (for example, the positive direction of the X-axis) will be defined as rearward.

The moving unit 400 causes the injection unit 300 to advance and retreat with respect to the mold unit 800. The moving unit 400 presses the nozzle 320 against the mold unit 800, thereby generating a nozzle touch pressure. The moving unit 400 includes a hydraulic pump 410, a motor 420 serving as a drive source, a hydraulic cylinder 430 serving as a hydraulic actuator, and the like.

The hydraulic pump 410 has a first port 411 and a second port 412. The hydraulic pump 410 is a pump that can rotate in both directions, and switches rotation directions of the motor 420 such that a hydraulic fluid (for example, oil) is suctioned from any one of the first port 411 and the second port 412 and is discharged from the other to generate a hydraulic pressure. The hydraulic pump 410 can suction the hydraulic fluid from a tank, and can discharge the hydraulic fluid from any one of the first port 411 and the second port 412.

The motor 420 operates the hydraulic pump 410. The motor 420 drives the hydraulic pump 410 in a rotation direction and with a rotation torque in accordance with a control signal transmitted from the control device 700. The motor 420 may be an electric motor, or may be an electric servo motor.

The hydraulic cylinder 430 has a cylinder body 431, a piston 432, and a piston rod 433. The cylinder body 431 is fixed to the injection unit 300. The piston 432 partitions an inside of the cylinder body 431 into a front chamber 435 serving as a first chamber and into a rear chamber 436 serving as a second chamber. The piston rod 433 is fixed to the stationary platen 110.

The front chamber 435 of the hydraulic cylinder 430 is connected to the first port 411 of the hydraulic pump 410 via a first flow path 401. The hydraulic fluid discharged from the first port 411 is supplied to the front chamber 435 via the first flow path 401, whereby the injection unit 300 is pressed forward. The injection unit 300 advances, and the nozzle 320 is pressed against the stationary mold 810. The front chamber 435 functions as a pressure chamber that generates the nozzle touch pressure of the nozzle 320 by means of the pressure of the hydraulic fluid supplied from the hydraulic pump 410.

On the other hand, the rear chamber 436 of the hydraulic cylinder 430 is connected to the second port 412 of the hydraulic pump 410 via a second flow path 402. The hydraulic fluid discharged from the second port 412 is supplied to the rear chamber 436 of the hydraulic cylinder 430 via the second flow path 402, whereby the injection unit 300 is pressed rearward. The injection unit 300 retreats, and the nozzle 320 is separated from the stationary mold 810.

In the present embodiment, the moving unit 400 includes the hydraulic cylinder 430, but the present invention is not limited thereto. For example, instead of the hydraulic cylinder 430, an electric motor and a motion conversion mechanism that converts a rotary motion of the electric motor into a linear motion of the injection unit 300 may be used.

### Storage Medium for Each Component

In the injection molding machine 10 according to the present embodiment, a storage medium is provided for each component that can be attached to and detached from the injection molding machine 10. For example, a storage medium 341A is provided in the plasticizing motor encoder 341. A storage medium 351A is provided in the injection motor encoder 351. A storage medium 170A is provided in the motion conversion mechanism 170.

In the present embodiment, a storage medium may be attached to any component that is replaceable. For example, a storage medium may be provided in the mold clamping motor encoder 161. A storage medium may be provided in the toggle mechanism 150. A storage medium may be provided in an intelligent power module (IPM) (not shown) in which a circuit related to a power supply of the injection molding machine 10 is mounted. In addition, a storage medium may be provided in each of the plasticizing motor 340, the injection motor 350, and the mold clamping motor 160.

The storage media (for example, the storage media 341A, 351A, and 170A) provided in the components are connected to the control device 700 in a wired manner or wirelessly. In a case of being wirelessly connected to the control device 700, for example, the storage medium may be provided as a non-contact type IC chip, and may realize communication and power generation by means of a wireless signal output from a wireless communication device (not shown) connected to the control device 700. Accordingly, even if the storage medium is not directly connected to the control device 700, information can be read according to the control from the control device 700.

### Control Device

For example, the control device 700 (an example of a controller) is configured to include a computer, and has a central processing unit (CPU) 701, a storage medium 702 such as a memory, an input interface 703, an output interface 704, and a communication interface 705 as shown in FIGS. 1 and 2. The control device 700 performs various types of control by causing the CPU 701 to execute a program stored in the storage medium 702. In addition, the control device 700 receives a signal from the outside through the input interface 703, and transmits the signal to the outside through the output interface 704.

The control device 700 repeatedly performs the plasticizing process, the mold closing process, the pressurizing process, the mold clamping process, the filling process, the holding pressure process, the cooling process, the depressurizing process, the mold opening process, the ejection process, and the like, thereby repeatedly manufacturing the molding product. A series of operations for obtaining the molding product, for example, an operation from the start of the plasticizing process to the start of the subsequent plasticizing process, will be referred to as a “shot” or a “molding cycle”. In addition, a time required for one shot will be referred to as a “molding cycle time” or a “cycle time”.

For example, one molding cycle has the plasticizing process, the mold closing process, the pressurizing process, the mold clamping process, the filling process, the holding pressure process, the cooling process, the depressurizing process, the mold opening process, and the ejection process in this order. The order described here is the order of the start times of the respective processes. The filling process, the holding pressure process, and the cooling process are performed during the mold clamping process. The start of the mold clamping process may coincide with the start of the filling process. The completion of the depressurizing process coincides with the start of the mold opening process.

A plurality of processes may be performed at the same time in order to shorten the molding cycle time. For example, the plasticizing process may be performed during the cooling process of the previous molding cycle or may be performed during the mold clamping process. In this case, the mold closing process may be performed in an initial stage of the molding cycle. In addition, the filling process may start during the mold closing process. In addition, the ejection process may start during the mold opening process. In a case where an on-off valve for opening and closing a flow path of the nozzle 320 is provided, the mold opening process may start during the plasticizing process. The reason is as follows. Even in a case where the mold opening process starts during the plasticizing process, when the on-off valve closes the flow path of the nozzle 320, the molding material does not leak from the nozzle 320.

One molding cycle may include a process other than the plasticizing process, the mold closing process, the pressurizing process, the mold clamping process, the filling process, the holding pressure process, the cooling process, the depressurizing process, the mold opening process, and the ejection process.

For example, after the holding pressure process is completed and before the plasticizing process starts, a pre-plasticizing suck-back process of causing the screw 330 to retreat to a preset plasticizing start position may be performed. The pressure of the molding material accumulated in front of the screw 330 before the plasticizing process starts can be reduced, and a sudden retreat of the screw 330 when the plasticizing process starts can be prevented.

In addition, after the plasticizing process is completed and before the filling process starts, a post-plasticizing suck-back process may be performed in which the screw 330 is caused to retreat to a preset filling start position (also referred to as an “injection start position”). The pressure of the molding material accumulated in front of the screw 330 before the filling process starts can be reduced, and a leakage of the molding material from the nozzle 320 before the filling process starts can be prevented.

The control device 700 is connected to an operation device 750 that receives an input operation of a user, and to a display device 760 that displays a screen.

For example, the operation device 750 and the display device 760 may be integrated with each other in a form of a touch panel 770. The touch panel 770 serving as the display device 760 displays the screen under the control of the control device 700. For example, the screen of the touch panel 770 may display settings of the injection molding machine 10, and information on a current state of the injection molding machine 10. The touch panel 770 can receive an operation in a displayed screen region. In addition, for example, the screen region of the touch panel 770 may display a button for accepting the input operation of the user or an operation portion such as an input field. The touch panel 770 serving as the operation device 750 detects an input operation of the user on the screen, and outputs a signal corresponding to the input operation to the control device 700. In this manner, for example, while checking information displayed on the screen, the user can perform setting (including an input of a set value) of the injection molding machine 10 by operating the operation portion provided on the screen. In addition, the user can operate the injection molding machine 10 corresponding to the operation portion by operating the operation portion provided on the screen. For example, the operation of the injection molding machine 10 may be an operation (including stopping) of the mold clamping unit 100, the ejector unit 200, the injection unit 300, the moving unit 400, or the like. In addition, the operation of the injection molding machine 10 may be switching between the screens displayed on the touch panel 770 serving as the display device 760.

A case has been described in which the operation device 750 and the display device 760 of the present embodiment are integrated with each other as the touch panel 770. However, both of these may be independently provided. In addition, a plurality of the operation devices 750 may be provided. The operation device 750 and the display device 760 are disposed on the operation side (a negative direction of the Y-axis) of the mold clamping unit 100 (more specifically, the stationary platen 110). For example, the operation device 750 can receive an input of a numerical value or of text from a physically provided button, a software keyboard displayed on the display device 760, or the like.

### One Embodiment

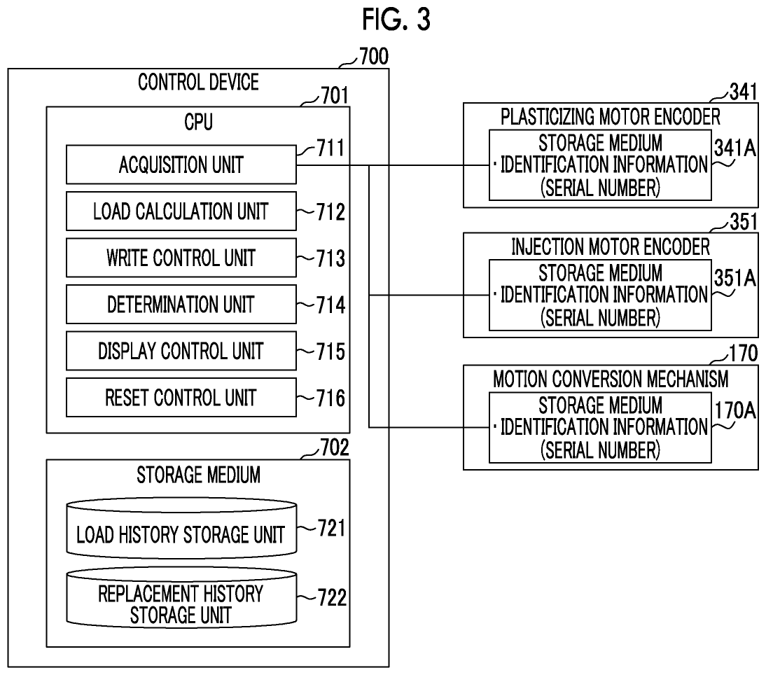

FIG. 3 is a functional block diagram showing components of the control device 700 of the injection molding machine 10 according to the embodiment and the storage media of the components mounted on the injection molding machine 10.

The control device 700 of the injection molding machine 10 is connected so that the control device 700 can read information from the storage media provided in the components mounted on the injection molding machine 10. In the example shown in FIG. 3, the storage medium 341A of the plasticizing motor encoder 341, the storage medium 351A of the injection motor encoder 351, and the storage medium 170A of the motion conversion mechanism 170 are shown. In FIG. 3, for ease of description, only the storage media 341A, 351A, and 170A are shown. However, the control device 700 can read information from any storage media provided in the components.

The storage medium 341A of the plasticizing motor encoder 341 stores identification information of the plasticizing motor encoder 341. The identification information may be any information that can identify the plasticizing motor encoder 341, and may be, for example, a serial number.

The storage medium 351A of the injection motor encoder 351 stores identification information of the injection motor encoder 351. The identification information may be any information that can identify the injection motor encoder 351, and may be, for example, a serial number.

The storage medium 170A of the motion conversion mechanism 170 stores identification information of the motion conversion mechanism 170. The identification information may be any information that can identify the motion conversion mechanism 170, and may be, for example, a serial number.

Each functional block of the CPU 701 of the control device 700 is conceptual, and may not necessarily be configured to be physical as shown. All or a portion of each functional block can be configured to be functionally or physically distributed and integrated in any desired unit. Each processing function performed in each functional block is realized by a program in which all or any desired partial functions are performed by the CPU 701. Alternatively, each functional block may be realized as hardware using a wired logic. As shown in FIG. 3, the CPU 701 of the control device 700 includes an acquisition unit 711, a load calculation unit 712, a write control unit 713, a determination unit 714, a display control unit 715, and a reset control unit 716. In addition, the control device 700 includes a load history storage unit 721 and a replacement history storage unit 722 in the storage medium 702.

The load history storage unit 721 stores a history of a load generated in a component by injection molding (an example of an operation) of the injection molding machine 10. For example, the load history storage unit 721 stores identification information of a component in association with a total value of the loads generated in the component after the component is mounted. As a specific example, the load history storage unit 721 stores the total value of the load in association with the identification information of the component for each of the plasticizing motor encoder 341, the injection motor encoder 351, and the motion conversion mechanism 170.

The component for which the load history storage unit 721 stores the history of the load may be any component that is attachable to and detachable from the injection molding machine 10, and examples thereof include the cylinder 310, the screw 330, the injection motor 350, and the plasticizing motor 340. The component for which the load history storage unit 721 stores the history of the load may be a component not shown in FIG. 1, or may be, for example, the IPM for managing the power supply of the injection molding machine 10. In addition, even in a case where no storage medium is provided in a component, the load history storage unit 721 may store a history of a load of the component without associating the history of the load of the component with identification information of the component.

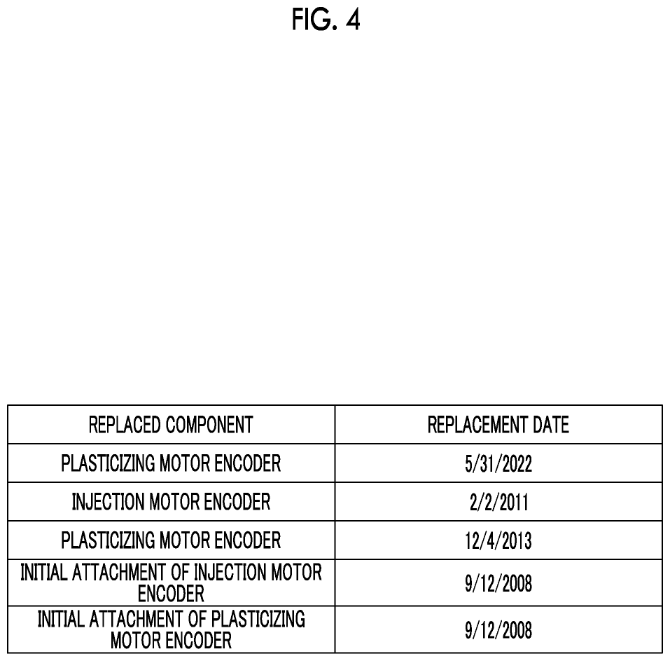

The replacement history storage unit (an example of replacement history information) 722 holds histories of replaced components in the injection molding machine 10. FIG. 4 is a view illustrating a table structure of the replacement history storage unit 722 according to the present embodiment. As shown in FIG. 4, the replacement history storage unit 722 stores the replaced components (names of the replaced components) and replacement dates in association with each other. In the example shown in FIG. 4, the replacement history storage unit 722 stores that the plasticizing motor encoder 341 and the injection motor encoder 351 were initially attached on Sep. 12, 2008. Furthermore, the replacement history storage unit 722 stores the replacement of components for each of the plasticizing motor encoder 341 and the injection motor encoder 351 together with the replacement date. The components for which the replacement history storage unit 722 manages the replacement are not limited to the plasticizing motor encoder 341 and the injection motor encoder 351, and any replaceable part in the injection molding machine 10 is subjected to management. In addition, the replacement history storage unit 722 may be provided for each component to be managed.

The acquisition unit 711 acquires various kinds of information regarding the injection molding machine 10. For example, the acquisition unit 711 acquires setting information set in the components for performing injection molding in the injection molding machine 10. For example, the acquisition unit 711 may acquire setting information regarding the mold clamping of the mold unit 800 in order to calculate a load generated in the motion conversion mechanism 170.

Furthermore, the acquisition unit 711 acquires measurement results from various sensors provided in the injection molding machine 10. For example, the acquisition unit 711 may acquire a measurement result of a stress or load generated in the motion conversion mechanism 170 from a detector provided in the motion conversion mechanism 170. The information acquired by the acquisition unit 711 according to the present embodiment is not limited to the above-described information, and may be any information stored as load history information or information for calculating the stored information.

The load calculation unit 712 calculates load information for each component based on the information acquired by the acquisition unit 711. For example, the load calculation unit 712 calculates the load information generated in the component based on the setting information set in the component, measurement values measured by various sensors, or the like. The calculated load may be corrected based on the number of cycles in which the load is generated or on an operation time.

For example, the load calculation unit 712 calculates load information for each of the plasticizing motor encoder 341 and the injection motor encoder 351. The load information of the plasticizing motor encoder 341 and the injection motor encoder 351 may be any information regarding the loads generated in the components, and may be, for example, the number of cycles or the operation time. Otherwise, the load information may be the degree of wear derived from the measurement results of the sensors related to the components.

As another example, the load calculation unit 712 calculates load information of the motion conversion mechanism 170. The load information of the motion conversion mechanism 170 may be a numerical value indicating the load calculated based on the measurement result of the stress or load generated in the motion conversion mechanism 170.

Alternatively, the load information of the motion conversion mechanism 170 may be a numerical value indicating a load generated in the motion conversion mechanism 170 calculated based on the setting information regarding the mold clamping of the mold unit 800. Furthermore, the load information of the motion conversion mechanism 170 may be the number of cycles or an operation time.

The load calculation unit 712 according to the present embodiment calculates load information for each component for which the history of the load is stored in the load history storage unit 721. In the present embodiment, the load information may also be calculated by correcting the operation time (including the number of cycles) or an energization time based on an operation status of the component.

For example, in a case where a history of a load of the injection motor 350 is stored in the load history storage unit 721, the load calculation unit 712 calculates load information of the injection motor 350. The load calculation unit 712 holds a load reference table for deriving the load information of the injection motor 350. The load reference table is a three-dimensional table in which a combination of an operating frequency, a carrier frequency, and an output current value (an example of an operation status), and a load generated in the injection motor 350 are associated with each other. Then, the load calculation unit 712 derives the load information generated in the injection motor 350 based on the operating frequency, the carrier frequency, and the output current value acquired by the acquisition unit 711 by referring to the load reference table. Then, the load calculation unit 712 uses the derived load information as the load of the injection motor 350 for each cycle. In a case where injection molding is performed in a plurality of cycles, the write control unit 713, which will be described later, adds the load information×the number of cycles to the history of the load of the injection motor 350 held by the load history storage unit 721. Accordingly, the load history storage unit 721 holds the total load information generated in the injection motor 350. For example, the load information is information indicating a magnitude of the load generated in the component as a numerical value. However, the load information may be any information that can express the load.

For example, in a case where the load history storage unit 721 stores a history of a load of the IPM, the load calculation unit 712 calculates load information of the IPM. The load calculation unit 712 estimates a flowing current value from the current setting of the IPM, or calculates a current value measured by various sensors. Then, the load calculation unit 712 holds a heat circuit model of the IPM in advance, and calculates a calorific value of the IPM (an example of the operation status) from the heat circuit model and the current value. Then, a correspondence relationship between the calorific value and the load of the IPM is held in advance, and the load information indicating the load generated in the IPM is calculated based on the correspondence relationship and the calorific value. Then, the write control unit 713, which will be described later, adds the calculated load information to the history of the load of the IPM held by the load history storage unit 721. Accordingly, the load history storage unit 721 holds the total load information generated in the IPM.

Similar to the above-described component, the load calculation unit 712 includes a load information calculation method for each component provided in the injection molding machine 10. For example, the load calculation unit 712 may calculate load information of the cylinder 310 and the screw 330 based on the operation time (including the number of cycles) or on the energization time of the injection molding machine 10 acquired by the acquisition unit 711.

The load information calculation method is shown as an example, and an appropriate load information calculation method may be used for each component. The load information calculated for each component is stored in a storage medium provided for the corresponding component. As described above, in the present embodiment, each component can hold the total load information generated in itself.

The write control unit 713 performs write control of the load information for each component calculated by the load calculation unit 712 as having been caused by the injection molding (an example of an operation) by the injection molding machine 10, on the load history storage unit 721.

For example, the write control unit 713 adds the load information calculated for the plasticizing motor encoder 341 to a history of a load associated with the identification information of the plasticizing motor encoder 341. For example, the write control unit 713 adds the load information calculated for the injection motor encoder 351 to a history of a load associated with the identification information of the injection motor encoder 351. For example, the write control unit 713 adds the load information calculated for the motion conversion mechanism 170 to a history of a load associated with the identification information of the motion conversion mechanism 170.

In addition, even if the history of the load of the component is not associated with the identification information of the corresponding component, the write control unit 713 may perform write control of the history of the load of the component based on the load information of the component.

For example, the write control unit 713 may add the load information calculated for the injection motor 350 to the history of the load of the injection motor 350. Furthermore, the write control unit 713 may add the load information calculated for the IPM to the history of the load of the IPM.

As another example, the write control unit 713 may add the load information calculated for the injection motor 350 to the history of the load of the injection motor 350. Furthermore, the write control unit 713 may add the load information calculated for the IPM to the history of the load of the IPM. Furthermore, the write control unit 713 may add the load information calculated for the cylinder 310 to a history of a load of the cylinder 310. Furthermore, the write control unit 713 may add the load information calculated for the screw 330 to a history of a load of the screw 330.

The determination unit 714 determines whether or not a change related to attachment or detachment of a component provided in the injection molding machine 10 is detected.

In a case where a storage medium that stores identification information is provided in a component, the determination unit 714 determines whether or not the identification information stored in the storage medium provided in the component matches the identification information stored in the load history storage unit 721 of the storage medium 702.

For example, the time at which the determination is performed may be after the power supply of the injection molding machine 10 is turned on. In addition, there are some components that can be replaced while the power supply is in an ON state. Therefore, the determination unit 714 may perform the determination every predetermined time (for example, several minutes).

The determination unit 714 according to the present embodiment does not limit the determination of whether or not the component has been replaced to whether or not the identification information matches. For example, the determination unit 714 may detect whether or not a maintenance cover of the injection molding machine 10 has been detached. That is, in a case where the maintenance cover is detached, the determination unit 714 determines that there is a possibility that a component inside the maintenance cover has been replaced.

The display control unit 715 controls the display device 760 to display information. For example, the display control unit 715 controls a display of a list of loads of components.

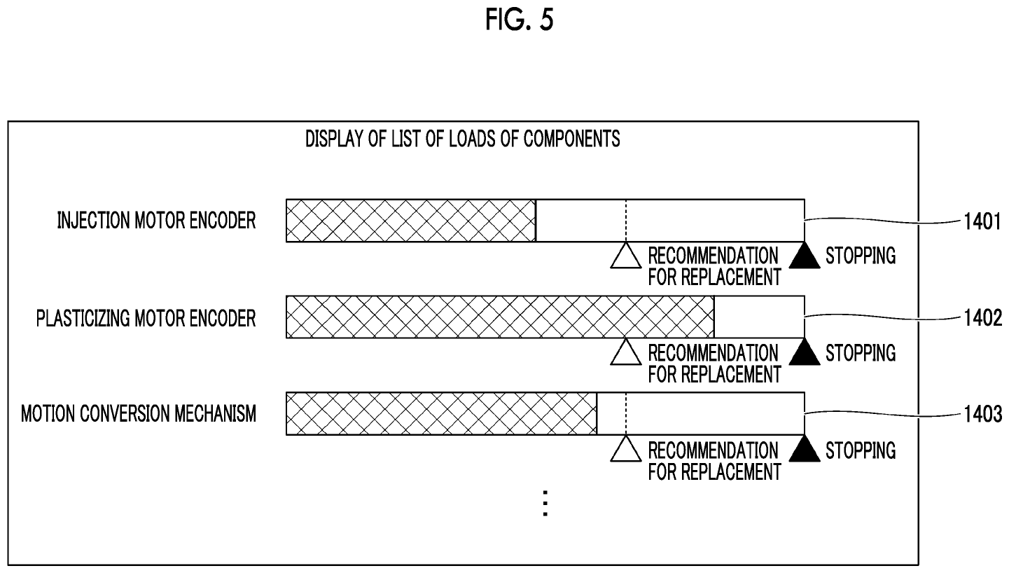

FIG. 5 shows a screen example of a display of a list of loads of components displayed by the display control unit 715 according to the present embodiment. In the screen example shown in FIG. 5, a total value of load information for each component is shown. In the example shown in FIG. 5, a total value 1401 of the load information of the injection motor encoder 351, a total value 1402 of the load information of the plasticizing motor encoder 341, and a total value 1403 of the load information of the motion conversion mechanism 170 are shown. In addition, in the screen example, a reset button for resetting the load information for each component may be provided. Furthermore, there is a possibility that it is determined that the component has been replaced even though the component has not been replaced. Therefore, in the screen example, in a case where the load information for each component is reset, a cancel button for canceling the reset may be displayed.

In the example shown in FIG. 5, the load information for each component is displayed as a bar graph. The bar graph shows a recommendation for replacement and stopping. That is, the bar graph indicates that in a case where the total value of the load information increases to a value indicating the recommendation for a replacement, replacement of the component is recommended. The bar graph indicates that in a case where the total value of the load information increases to a value indicating the stopping, the operation of the injection molding machine 10 is stopped.

For example, the screen of a display of a list of loads shown in FIG. 5 is displayed on the display device 760 according to an operation of a user. By displaying the screen, the user can recognize a replacement time for each component.

In a case where a condition in which a component is replaced is satisfied, the reset control unit 716 initializes the total value of the load information indicated in the history of the load of the component. Furthermore, the reset control unit 716 registers information (for example, the name of the component) for identifying the replaced component in the replacement history storage unit 722. Specific conditions for performing initialization and the like will be described later.

In the related art, in a case where the user replaces a component, it is necessary for the user to initialize the load information of the replaced component. Contrary to this, in the present embodiment, it is detected whether or not the component is replaced, and the history of the load is updated according to a detection result thereof. Next, specific control related to the replacement of the component in the control device 700 according to the present embodiment will be described.

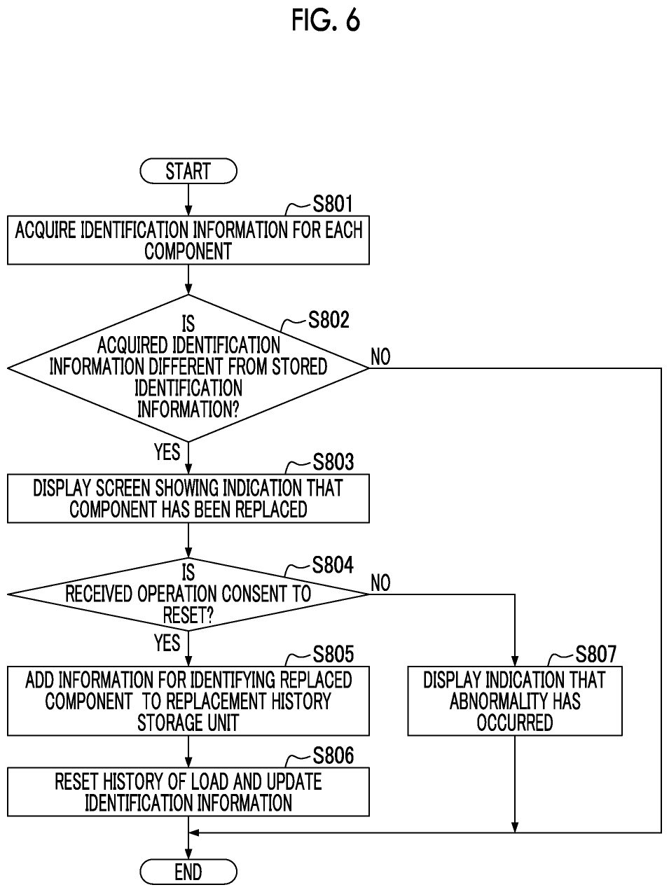

FIG. 6 is a flowchart showing first control related to the replacement of the component in the control device 700 according to the present embodiment.

First, the acquisition unit 711 acquires, for each component, identification information from the storage medium provided in the component (S801).

Then, the determination unit 714 determines whether or not the acquired identification information (first identification information) is different from the identification information (second identification information) stored in the load history storage unit 721 (S802). In a case where it is determined that there is no difference, in other words, the identification information of all the components matches (NO in S802), the process ends without any particular processing.

In a case where the determination unit 714 determines that the acquired identification information is different from the identification information stored in the load history storage unit 721, in other words, there is a component having identification information that does not match (YES in S802), the display control unit 715 displays a notification screen showing an indication that the history of the replaced component is to be reset (S803).

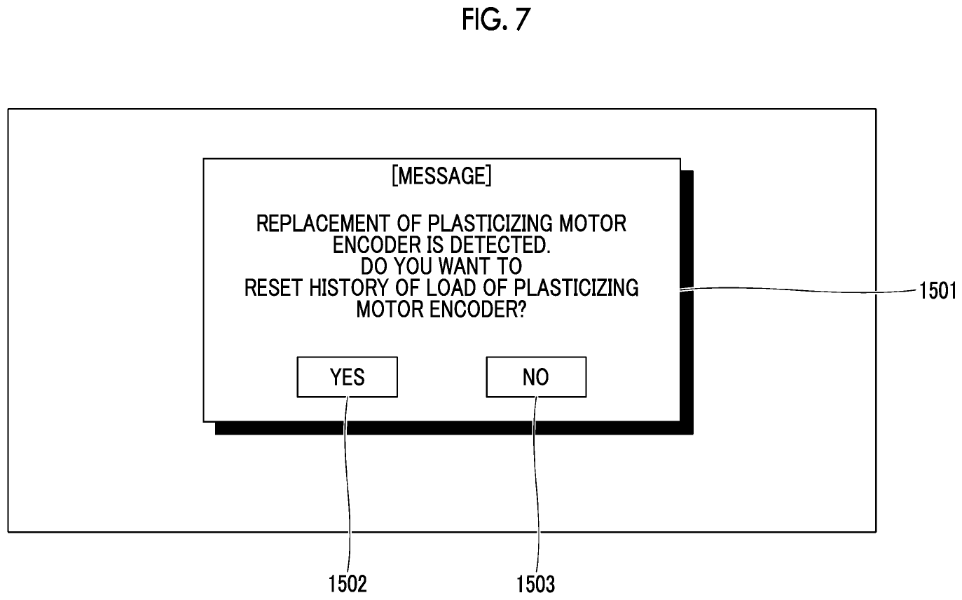

FIG. 7 is a view illustrating a notification screen of the replaced component displayed by the display control unit 715 according to the present embodiment. FIG. 7 is a screen displayed in a case where it is determined that the identification information stored in the storage medium 341A of the plasticizing motor encoder 341 does not match the identification information stored in the load history storage unit 721 of the storage medium 702.

As shown in FIG. 7, in a case where the replacement of the component is detected, a notification screen 1501 pops up. On the notification screen 1501, an indication that the component has been replaced and an indication that the history of the load of the component is to be reset are shown. In the present embodiment, the notification screen 1501 indicates that the replacement of the component is detected. Furthermore, on the notification screen 1501, as a notification of an indication of the resetting, a sentence “Do you want to reset the load of the plasticizing motor encoder?” is displayed as an indication of a request for consent to reset the history of the load of the component. In addition, on the notification screen 1501, a “Yes” button 1502 and a “No” button 1503 are displayed. In a case where the “Yes” button 1502 is pressed, an indication that the resetting is accepted is shown, and in a case where the “No” button 1503 is pressed, an indication that the resetting is not accepted is shown. In addition, in the present embodiment, an example of the screen in the case where the replacement is detected is shown. As another example of the notification of the indication of the resetting, advice about whether or not to perform the resetting is displayed, or a warning is displayed. Otherwise, in a case where the resetting is not canceled, it is conceivable to show an indication that the resetting will be performed.

In a case where the determination unit 714 receives the pressing of the “No” button 1503, in other words, in a case where the determination unit 714 determines that the received operation is not the consent to reset (NO in S804), the display control unit 715 displays an indication that an abnormality has occurred (S807), and the process ends. That is, even though the control device 700 has determined that the identification information does not match, as long as the component has not been replaced, there is a high probability that an abnormality has occurred in the reading of the identification information. Therefore, the control device 700 displays an indication that an abnormality has occurred.

On the other hand, in a case where the determination unit 714 receives the pressing of the “Yes” button 1502, in other words, when the determination unit 714 determines that the received operation is the acceptance of the resetting (YES in S804), the reset control unit 716 adds information for identifying the replaced component (for example, the name of the component) to the replacement history storage unit 722 together with a date (S805).

The reset control unit 716 resets (initializes) the history of the load corresponding to the component in the load history storage unit 721, and updates the identification information of the component to the identification information acquired in S801 (S806).

In the control device 700 according to the present embodiment, by performing the above-described control, information on the replaced components is added to the replacement history storage unit 722, and the history of the load of the replaced component stored in the load history storage unit 721 is initialized.

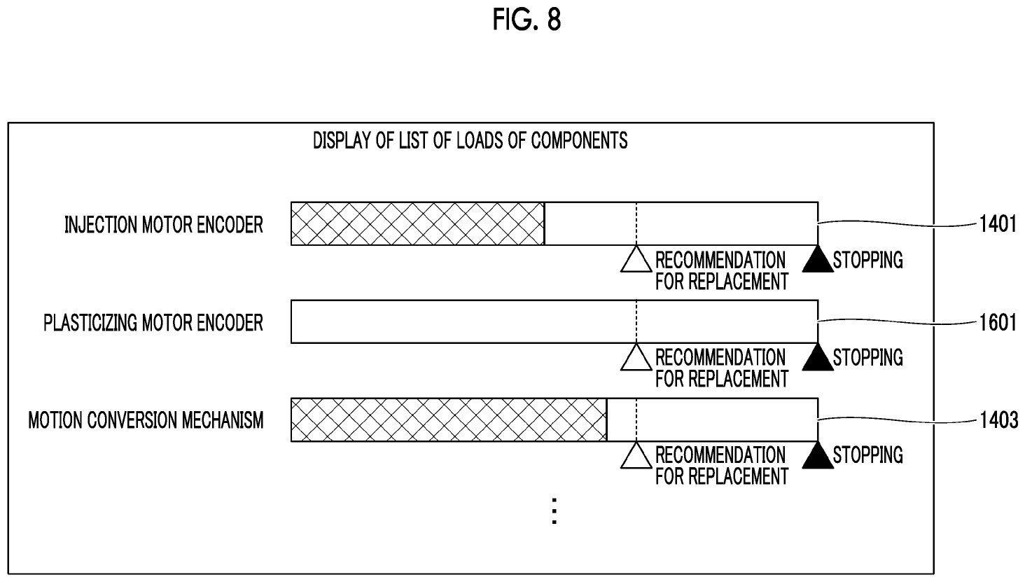

FIG. 8 shows a screen example of a display of a list of loads of components after the replacement of the component, which is displayed by the display control unit 715 according to the present embodiment. In the screen example shown in FIG. 8, a total value of load information for each component is shown. In the example shown in FIG. 8, the total value 1401 of the load information of the injection motor encoder 351, a total value 1601 of load information of the plasticizing motor encoder 341, and the total value 1403 of the load information of the motion conversion mechanism 170 are shown.

In the example shown in FIG. 8, since the plasticizing motor encoder 341 is replaced, the total value 1601 of the load information is initialized. By displaying the screen, the user can recognize that the plasticizing motor encoder 341 has been replaced.

The initialization of the history of the load of the component according to the present embodiment is not limited to the detection of the replacement of the component based on the identification information. For example, in a case where the maintenance cover of the injection molding machine 10 is detached, a process may be performed assuming that there is a possibility that the component has been replaced. Next, a process based on the maintenance cover will be described.

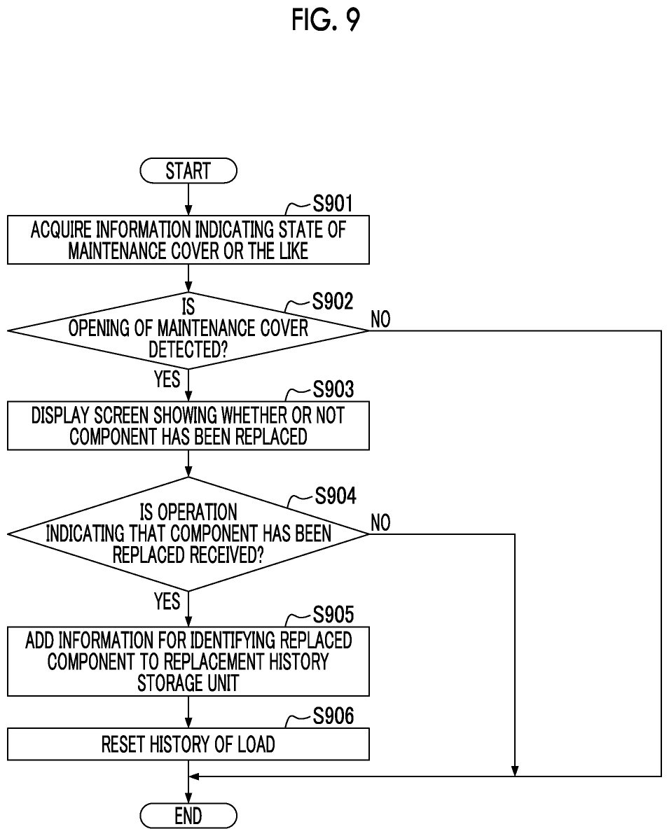

FIG. 9 is a flowchart showing second control related to the replacement of the component in the control device 700 according to the present embodiment.

First, the acquisition unit 711 acquires a detection signal indicating a state of the maintenance cover (not shown) or the like from a sensor or the like (S901).

Then, the determination unit 714 determines whether or not the maintenance cover has been opened, based on the acquired detection signal (S902). In a case where it is determined that the maintenance cover has not been opened (NO in S902), the process ends without any particular processing.

On the other hand, in a case where the determination unit 714 determines that the maintenance cover has been opened based on the acquired detection signal (YES in S902), the display control unit 715 displays a confirmation screen as to whether or not a component has been replaced (S903).

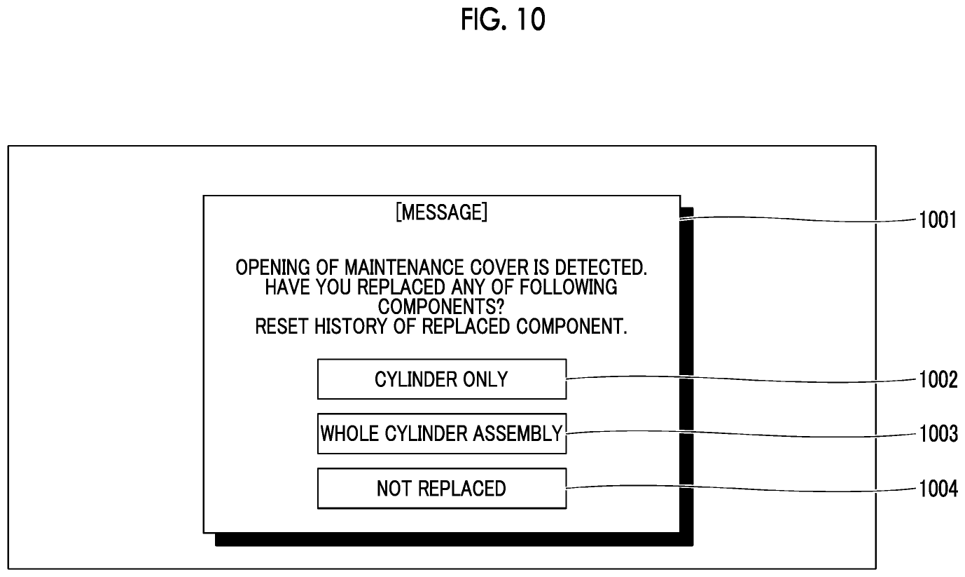

FIG. 10 is a view illustrating a confirmation screen as to whether or not a component has been replaced, which is displayed by the display control unit 715 according to the present embodiment.

In a case where it is detected that the maintenance cover is opened as shown in FIG. 10, a confirmation screen 1001 pops up. Since the maintenance cover is opened, on the confirmation screen 1001, it is confirmed whether or not a component that is attachable and detachable in a case where the maintenance cover is opened has been replaced.

On the confirmation screen 1001, an indication that the maintenance cover is opened and an indication of confirmation of whether or not a component has been replaced are shown. Furthermore, on the confirmation screen 1001, the replaced component can be selected. For example, on the confirmation screen 1001, a “cylinder only” button 1002, a “whole cylinder assembly” button 1003, and a “not replaced” button 1004 are displayed.

The “cylinder only” button 1002 indicates that only the cylinder 310 has been replaced, the “whole cylinder assembly” button 1003 indicates that a combination of a plurality of components (a combination of the cylinder 310 and the screw 330) has been replaced, and the “not replaced” button 1004 indicates that the component has not been replaced.

In a case where the determination unit 714 receives the pressing of the “not replaced” button 1004, in other words, in a case where the determination unit 714 determines that an operation indicating that the component has not been replaced is received (NO in S904), the process ends without any particular processing.

On the other hand, in a case where the determination unit 714 receives the pressing of the “cylinder only” button 1002 or the “whole cylinder assembly” button 1003, in other words, in a case where the determination unit 714 determines that an operation indicating that the component has been replaced is received (YES in S904), the reset control unit 716 adds information (for example, the name of the component) for identifying the replaced component to the replacement history storage unit 722 (S905). In a case where the “cylinder only” button 1002 is pressed, the reset control unit 716 adds information (for example, the name of the component) for identifying the cylinder 310 to the replacement history storage unit 722. In a case where the “whole cylinder assembly” button 1003 is pressed, the reset control unit 716 adds information (for example, the names of the components) for identifying each of the components constituting a cylinder assembly to the replacement history storage unit 722.

The reset control unit 716 resets (initializes) the history of the load corresponding to the component in the load history storage unit 721 (S906). The reset control unit 716 resets (initializes) the history of the load corresponding to the cylinder 310 in the case where the “cylinder only” button 1002 is pressed. The reset control unit 716 resets (initializes) the history of the load of each of the components constituting the cylinder assembly in the case where the “whole cylinder assembly” button 1003 is pressed.

### Modification Example

In the above-described embodiment, an example has been described in which the display control unit 715 displays a notification screen or a confirmation screen in a case where a change in attachment/detachment of a component is detected. However, in the above-described embodiment, control performed in the case where a change in attachment/detachment of a component is detected is not limited to displaying of a screen. In a modification example, an example in which control other than displaying is performed in the case where a change in attachment/detachment of a component is detected.

In a case where the determination unit 714 according to the present modification example determines that a change in attachment/detachment of the component is detected, for example, in a case where the determination unit 714 determines that the identification information stored in the storage medium provided in the component does not match the identification information stored in the load history storage unit 721 of the storage medium 702, the reset control unit 716 adds information (for example, the name of the component) for identifying the component to the replacement history storage unit 722. Furthermore, the reset control unit 716 resets (initializes) the history of the load corresponding to the component in the load history storage unit 721, and updates the identification information of the component stored in the load history storage unit 721. As described above, in the present modification example, in a case where the replacement of the component is detected, the replacement history storage unit 722 and the load history storage unit 721 may be updated without displaying a screen.

In the injection molding machine 10 according to the present modification example, the same effect as that of the above-described embodiment can be obtained by performing the above-described control. Furthermore, a burden on a worker can be reduced.

In the above-described embodiment and the modification example, an example of a component to be replaced is shown. In the above-described embodiment, the component to be replaced is not limited. For example, the above-described control may be applied to the sensors, the IPM, the drive components (screws, bearings, toggle links, linear guides, and various motors), and the plasticizing components (cylinders, heaters, and thermocouples) provided in the injection molding machine 10.

### Operations

Since the injection molding machine according to the present embodiment has the above-described configuration, the history of the load of the component can be reset in a case where the component is replaced. Therefore, the load generated in the component can be properly managed. That is, by appropriately managing the load, the injection molding machine can properly control a notification of an indication to prompt the replacement of the component, stopping the injection molding due to the load of the component, or the like.

The injection molding machine according to the present embodiment adds information for identifying the replaced component to the replacement history storage unit 722 each time the component is replaced, thereby managing a history of the replacement of the component. In the related art, the history of the replacement of the component is performed by a worker. However, since the injection molding machine 10 can manage the history of the replacement of the component, the burden on the worker can be reduced.

In the injection molding machine according to the above-described embodiment, in a case where the identification information is stored in the storage medium provided in the component, it is possible to confirm whether or not the component has been replaced based on the identification information stored in the storage medium. Therefore, it is possible to improve a detection accuracy of the replacement of the component.

Hitherto, the embodiments of the injection molding machine according to the present invention have been described. However, the present invention is not limited to the above-described embodiments. Various modifications, corrections, substitutions, additions, deletions, and combinations can be made within the scope of the appended claims. As a matter of course, all of these also belong to the technical scope of the present invention.

It should be understood that the invention is not limited to the above-described embodiment, but may be modified into various forms on the basis of the spirit of the invention. Additionally, the modifications are included in the scope of the invention.

What is claimed is:

1. An injection molding machine comprising:
a controller;
components that are attachable to and detachable from the injection molding machine; and
a storage medium that stores history information for each of the components,
wherein, in a case where the controller detects a change in attachment/detachment of a first component, the controller adds information indicating that the first component has been replaced to the history information, outputs an indication of initialization of the history information of the first component, or initializes the history information of the first component.

2. The injection molding machine according to claim 1,
wherein the storage medium includes, as the history information of the component, replacement history information that holds a history of replacement of the first component, and load history information that holds a load generated in the first component by an operation of the injection molding machine, and
in a case where the controller detects a change in attachment/detachment of the first component, or outputs an indication of initialization of the history information of the first component, the controller adds information indicating that the first component has been replaced to the replacement history information, and performs initialization of the load history information of the first component.

3. The injection molding machine according to claim 2,
wherein the controller updates the load history information with a value based on an operation time or on an energization time in the injection molding machine as information indicating a load of the component.

4. The injection molding machine according to claim 3,
wherein the controller sets a value obtained by correcting the operation time or the energization time in the injection molding machine based on an operation status of the component as the information indicating the load of the component.

5. The injection molding machine according to claim 1,
wherein the first component includes the storage medium that stores first identification information for identifying the first component,
the storage medium provided in the injection molding machine stores second identification information for identifying the first component, and
the controller detects whether or not the first identification information matches the second identification information as the change in attachment/detachment of the first component.
